(19) United States
(12) Patent Application Publication
(10) Pub. No.: US 2005/0265917 A1
(43) Pub. Date: Dec. 1, 2005

(54) Method for synthesizing high adsorptive nanometer scale titanium dioxide solution

(76) Inventor: Wen-Chuan Liu, Taipei (TW)

Correspondence Address: WEN-CHUAN LIU, 235 Chung-Ho, Box 8-24, Taipei, TW

(21) Appl. No.: 10/857,727

(22) Filed: Jun. 1, 2004

(51) Int. Cl. C01G 23/047

(52) U.S. Cl. 423/610

(57) ABSTRACT

A method for synthesizing high adsorptive nanometer scale titanium dioxide solution is disclosed. Titanium tetrachloride or titanium oxysulfate is dissolved and diluted in acid liquid and then ammonia water is used to change the pH value of the solution to be between 7 and 9 so as to generate titanium hydroxide. After washing or filtering, a form-transfer process is executed in predetermined condition. Clean titanic acid is agitated in de-ionized water and thus the titanic acid is uniformly mixed with de-ionized water; and then predetermined oxidant or inorganic acid, and modifier are added. Then a formation process is executed in a predetermined temperature and time so as to get a titanium dioxide sol-gel which can be applied to a surface of an object to be treated so as to form with film with preferred adsorption.

### FIELD OF THE INVENTION

The present invention relates to method for synthesizing high adsorptive nanometer scale titanium dioxide solution, and particular to a method for synthesizing nanometer scale titanium dioxide solution with high adsorption and which is easily formed as stable film. Namely, a series of chemical process is used to form nanometer scale titanium dioxide sol-gel solution with high adsorption and easily formed as stable films with particles sizes between 2 and 500 nm and the content of titanium dioxide in the solution is between 0.5 and 10%.

### BACKGROUND OF THE INVENTION

From 1970s, a large amount of documents disclosed methods for manufacturing semiconductor titanium dioxide. Most of the documents use normal chemical components, especially titanium dioxide particles, as raw material. The photochemical 1 reaction and semiconductor reaction are also discussed. The configuration of crystals and size of the particles will affect the efficiency of the reactions.

Based on the disclosed documents, to synthesize titanium dioxide photo-catalyst, most of the prior arts adopts chemical synthesis to make titanium dioxide particles. Although in many cases, the grinding method is used to make titanium dioxides (such as P-25 grinding method used by Degussa Co.). However, this method cannot make titanium dioxide particles with uniform particle size (from 10 to 500 nm) and the crystal configurations can not matched to required ones. Thereby, it is used in painting, cosmetic, correction fluid, etc. Effect of photo-catalyst cannot be presented. Although the grinding process is modified, supersonic grinding with supersonic oscillation or chemical grinding with acid liquid is adopted for improving the size and uniformity of titanium dioxide particles, but the effects of these improvements are finite. They cannot greatly improve the configurations of crystals. Thereby, the applications of the products are also confined.

For the chemical synthesis, liquid synthesis is the main method. In the prior art, chemical vapor deposition (CVD) method is adopted to grow titanium dioxide photo-catalyst film, which can provide high stability, high purity photo-catalyst, but manufacturing cost is high and only suitable for some specific products. This prior art cannot be used for mass-production.

Liquid synthesis is classified into two methods, organic solvent method and aqueous method. The aqueous method is a preferred one for making titanium dioxide photo-catalysts.

The organic solvent method uses Ti-alkyloxide:Ti(OR)4 in different solvents so as to form titanium dioxide powder or film depending on the heating process. One of these prior arts is disclosed in Japanese Patent No. 4-83537, in that, titanium alkyl-oxide is heated in ethylene glycol. In Japanese Patent No. 7-10037, titanium alkyl-oxide is heated in amino-alcohol so as to get titanium dioxide. Since the titanium alkyl-oxide is expensive and the operation must be performed in high temperature and high pressure. Thereby, the products by these ways are generally used as industrial chemical catalyst instead of civil purpose.

The aqueous synthesis are mostly disclosed in Japanese patents or Japanese related documents, such as Japanese Patent No. 7-171408, binding agent is added to the titanium tetrachloride and then heated. In Japanese Patent No. 6-293519, under the condition of pH 3, titanium tetrachloride solution is directly heated so as to form titanium dioxide sol-gel. The defect of this method is that a large amount of chloride retained so that the sol-gel is unstable and easy to precipitate. In Japanese Patent No. 9-71418, hydrogen peroxide solution is added to titanium hydroxide, and the pH is 6 to 8 and temperature is lower. In Japanese Patent No. 62-252319, hydrogen peroxide solution is added to titanium hydroxide, and the reaction condition of pH value is from 2 to 6, temperature is low and reaction time is longer. The particle size of the titanium dioxide sol-gel generated by these way is about 10 nanometers. Since the particles are mainly non-crystal, it is suitable for surface treatment, but it is not an effective photo-catalyst. In Japanese Patent No. 7-28614, pertitanic acid is heated and in Japanese Patent No. 285993, hydrogen peroxide solution is added to titanium hydroxide and then reaction temperature is increased so as to form titanium dioxide sol-gel. The products have photo-catalytic effect. Due to the property of hydrogen peroxide, the concentration of the titanium dioxide sol-gel is confined to be below 2%. Thereby, it cannot be widely used.

In Taiwan Patent No. 135895, titanium tetrachloride solution is added with organic acid. Then the solution is heated at temperature above 70° C. so as to form anatase titanium dioxide. The titanium dioxide sol-gel produced by this way is the right configuration and particle size, but the content of chloride is high (above 10 grams/liter). Thereby, the stability of the product is not preferred.

In Taiwan Patent No. 349981, the titanium tetrachloride reacts with ammonia water with a pH value of 2 to 6. Then the precipitate (titanium hydroxide or titanic acid) is filtered and rinsed. Hydrogen peroxide is added into the solution in low temperature (5 to 8° C.). The solution is agitated for a longer time so as to disperse non-crystal titanium dioxide which is unrelated to the present invention. In Taiwan Patent No. 393342, the titanium sulfate is heated to form titanium dioxide and then mono-proton acid (such as nitric acid, etc.) is added to the titanium dioxide for removing residue sulfate and solving titanium dioxide to reduce the particle size of the titanium dioxide. This prior art is also unrelated to the present invention. Taiwan Patent No. 443992 discloses a method for forming titanium dioxide film instead of sol-gel.

Another method for synthesizing the solution comprises the steps of dissolving, diluting, neutralizing (above steps are used in the prior art), and cleaning, form-transferring and formation the titanium compound in a predetermined acid liquid to acquired nanometer scale titanium dioxide photo-catalyst sol-gel. This prior art method is a skilled process which is stable and suitable for mass-production, but this process is only used in the titanium dioxide sol-gel which is not suitable for the succeeding steps and do not match to the processed objects.

As mentioned above, it is found that all the prior arts are aimed at titanium dioxide sol-gel, but the succeeding process and the object to be treated are not taken into consideration. The titanium dioxide sol-gel has no preferred adsorption and is not stable for a long time. Thereby, the application of the titanium dioxide sol-gel is confined.

### SUMMARY OF THE INVENTION

Accordingly, the primary object of the present invention is to provide a method for synthesizing high adsorptive nanometer scale titanium dioxide, wherein a series of chemical process is used to form nanometer scale titanium dioxide sol-gel solution. It is an adsorptive material with particle size between 2 and 500 nm and the content of titanium dioxide is between 0.5 and 10%. It is easy to form a suitable film.

To achieve above objects, the present invention provides a method for synthesizing high adsorptive nanometer scale titanium dioxide, wherein titanium tetrachloride or titanium sulfate is dissolved and diluted in acid liquid and then ammonia water is added to neutralize the solution with pH between 7 and 9 so as to generate titanium hydroxide. After washing or filtering, at the form-transfer process; clean titanic acid is agitated with de-ionized water and uniformly mixed; then predetermined amount of oxidant or inorganic acid and modifier is added. At the formation process; the form-transferred solution being performed with formation process in a predetermined temperature and time so as to get a sol-gel. The titanium dioxide sol-gel can be applied to a surface of an object to be treated so as to form the film with preferred adsorption.

The various objects and advantages of the present invention will be more readily understood from the following detailed description when read in conjunction with the appended drawing.

### BRIEF DESCRIPTION OF THE DRAWINGS

FIG. 1 shows the flow chart of the present invention.

### DETAILED DESCRIPTION OF THE INVENTION

In order that those skilled in this art can further understand the present invention, a description will be present in the following in detail. However, these descriptions and the appended drawings are only used to show those skills in the art to understand the objects, features, and characteristics of the present invention, but not to be used to confine the scope and spirit of the present invention defined in the appended claims.

The present invention provides a method for synthesizing high adsorptive nanometer scale titanium dioxide solution. The method comprises the prior art with steps of dissolving, diluting, neutralizing, and cleaning titanic compound in predetermined acid liquid to acquire titanium hydroxide or titanic acid. The titanium hydroxide are transferred into nanometer scale crystal titanium dioxide sol-gel with functions of photo-catalyst and self-cleaning. The method further comprises the following steps.

A form-transfer process in predetermined condition is performed. Clean titanic acid is agitated with de-ionized water and thus the titanic acid is uniformly mixed. Predetermined amount of oxidants or inorganic acids (or organic acid), and modifiers are added.

Then a formation process is performed for the form-transferred solution in a predetermined temperature and time so as to get titanium dioxide sol-gel.

The pH value of the sol-gel is adjusted and the titanium dioxide sol-gel is filtered from the solution. Finally, the filtered sol-gel is packaged.

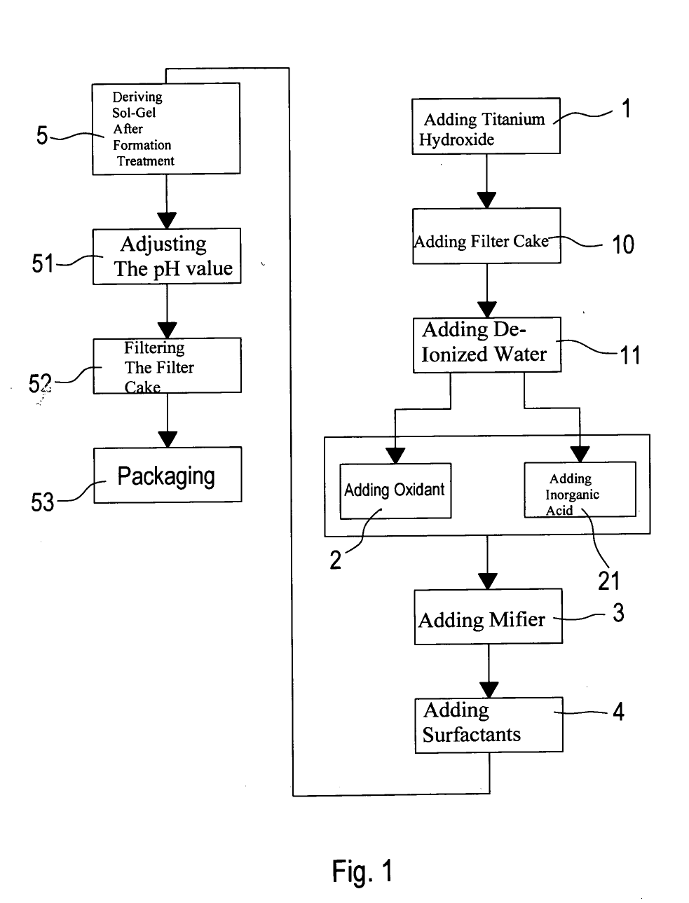

With reference to FIG. 1, the method for synthesizing high adsorptive nanometer scale titanium dioxide solution of the present invention is mainly for improving the bad adsorption and film property as that are manufactured from prior art. The novel process of the present invention is that the titanium dioxide sol-gel is further performed with the process of form transfer and formation so as to acquire titanium dioxide sol-gel with functions of photo-catalyst and self-cleaning.

In the form transfer process, the cleaned filter cake 10 of titanium hydroxide 1 (or called as titanic acid) is added in de-ionized water 11. The solution is agitated through 12 minutes. Then oxidant 2 or inorganic acid 21 is added to the solution as required. Then modifier 3 and required surfactant 4 are added. In the present invention, the oxidant 2 is selected from at least one of perchloric acid, periodide acid, potassium permanganate, sodium permanganate, and nitric acid; and 1 to 200 grams/liters oxidant is added. The inorganic acid 21 is selected from at least one of perchloric acid, periodide acid, nitric acid, phosphoric acid, hydrochloric acid, sulfuric acid, and hydrogen iodide, hydrobromic acid; per liter solution is added with 1 to 120 grams inorganic acid. The organic acid is selected from one of oxalic acid, citric acid, picric acid, formic acid, acetic acid, benzoic acid, salicylic acid, and derivatives of ammonium compounds; and the added inorganic acid in the form transfer-process is between 0.1 gram/liter to 150 grams/liter. The modifier 3 is selected from one of silicate, Poly-aluminium chloride(PAC), aluminium sulfate, and silane depending on a final product required; the amount of modifier used in form-transfer process is between 0.05˜75 milliliter/liter. The surfactant 4 used in form-transfer process is selected from one of polyvinyl alcohol (PVA); polypropylene alcohol (PPA); and mixture of polyvinyl alcohol (PVA)/polypropylene alcohol (PPG); poly-alcohols selecting from adding Polyethylene glycol, Polypropylene glycol and butadiene Polypropylene; and ploy-ethers selecting from Polyoxyethylene phenol ether/Polyoxypropylene alkyl phenol ether/Polyoxypropylene phenol ether/Polyoxypropylene alkyl phenol ether, and Polyoxyethylene Polyoxypropylene ether; and a molecular weight of the surfactant used in the form-transfer process is between 200-7000. The amount of interface activator used in form-transfer process is between 10-15000 ppm and the agitating speed is between 30-300 rpm; the time for form-transfer process is 10 to 120 minutes; and the temperature in form-transfer process is retained at 10 to 95° C.

One or both of the oxidant 2 and the acid 21 can be added to the de-ionized water solution, which is determined by the requirement of final product. If the titanium dioxide sol-gel solution is directly used to spray a surface, the oxidant 2 is a preferred selection. If the final sol-gel is used to form film or to final finish work, or requires higher density, inorganic acid 21 is a preferred selection, or both the oxidant or the inorganic acid 21 are used. The selection of inorganic acid is based on the object to be used and the environment.

The modifier 3 is determined by the objects to be treated, for example, for natural materials, such as wood, paper, fibers, etc., the silicate, Poly-aluminium chloride(PAC), and aluminium sulfate are preferred. For glass, metal, stone, ceramic, etc., silicate is preferred. For manmade fibers, polymers, silicate and silane, are preferred.

The titanic acid added with modifier 3 and oxidant 2 or inorganic acid 21 is form-transferred in a set of temperature and time. In the present invention, the agitating speed is between 30-300 rpm; the time for form-transfer process is 10 to 120 minutes; and the temperature in form-transfer process is retained at 10 to 95° C.

The solution after form-transfer process is executed with the formation process. The agitating speed in formation process is from 30 to 300 rpm with a temperature between 50 and 95° C. through a time period of 4 to 72 hours which are determined by a desired product;

The titanium dioxide sol-gel 5 after formation is performed with the steps of pH adjusting, filtering, and package; wherein the pH adjustment is performed according to requirements of the product.

In the following, a plurality of embodiments about the method of the present invention will be illustrated so that those skills in the art can understand the present invention.

### First Embodiment

In the first embodiment of the present invention, the method for synthesizing high adsorptive nanometer scale titanium dioxide solution is performed by the following processes. 10 liters de-ionized water is added to a reaction tank with a volume of 20 liters. The agitating speed is set at 300 rpm. The reaction tank is retained in temperature of 5 to 10° C. by ice-water bath. A predetermined amount, 500 grams, of titanium tetrachloride (with a ratio of 98%) is added to the water with a speed of 4 ml/min by using a dosing pump. When all the titanium tetrachloride is added and agitated through 2 hours until the liquid is clear and become transparent, ammonia water with a concentration of 20% is added with an addition speed of 10 ml/min and an agitation speed of 600 rpm. Variation of pH value is monitored. When the pH value is attained to 4.0, the addition speed is changed to 2-4 ml/min until the pH value is achieved to 7.5 to 8.0. Above solution is filtered with a vacuum filter. Then filter cake (containing titanium hydroxide) from the solution is added to a clean 200 liters tank. The tank has been filled with 100 liters running water or soft water. The agitation speed is set at 600 rpm and the agitation time period is 2 hours until the filter cakes are uniformly mixed. Then it is filtered. The process of cleaning and filtering are repeated three times. Then the filter cake is transferred to a form-transfer and formation tank. 20 liters de-ionized water is added to the tank. The agitation speed is retained at 300 rpm. The filter cake is added and then the solution is agitated through one hour so that they are mixed uniformly. Then 50 ml of perchloric acid (HClO₄) is added to the solution. The solution is agitated through 80 min. The temperature of solution is increased to 80 to 90° C. The solution is agitated through 6 hours. The temperature of the solution is decreased and pH is adjusted. Then the solution is packaged as product. In the present invention, the acquired titanium dioxide sol-gel is colorless or yellow transparent solution with a pH value of about 5 to 9. The content of titanium dioxide is about 1% and the particle size is about 5 to 50 nm, which is presented as needle-like or sheet-like crystal. The present invention can be directly used in spray treatment or is processed as film so as to have the function of self-cleaning. If the solution of the present invention is radiated by ultra-violet light, it has the function of sterilization. The product is performed with spraying treatment, and then dried at room temperature to become a thin film. Then an adhesion test by using 3M tape is applied to the film. As a result, it appear that no film falls off, but in the prior art, for the film of titanium dioxide sol-gel without adding silicic acid, when the film is experienced with spraying treatment, the film will fall off in the test. Thereby, the present invention is better than the prior art.

### Second Embodiment

The process is identical to the first embodiment except that in the form-transfer process, 100 milliliter of the poly aluminium chloride (10%) is used to replace silicic acid. Operation conditions are same as the first embodiment. The acquired titanium dioxide sol-gel is yellow transparent solution with a pH value between 7 and 9. The content of titanium dioxide is 1%. The particle size is about 5 to 30 nm with needle-like or sheet-like crystals. The product can be directly used in spray treatment and then is processed as film so as to have the function of self-cleaning. If the solution of the present invention is radiated by ultra-violet light, it has the function of sterilization. The product is performed with spraying treatment, and then dried at room temperature to become a thin film. Then the adhesion test by using 3M tape is applied to the film. As a result, it appears that no product falls off, but for the film of titanium dioxide sol-gel without adding silicic acid, when the film is experienced with spraying treatment, the film will fall off in the test.

### Third Embodiment

The process is the same as the first embodiment, but in the final formation process, the agitation time is prolonged to 48 hours from the original six hours. The acquired titanium dioxide sol-gel is transparent or yellow transparent solution with a pH value between 4 and 9. The content of titanium dioxide is 1%. The particle size is about 20 to 100 nm with needle-like or sheet-like crystals. The product is directly performed with spraying treatment, and then dried at room temperature to become a thin film. As a result, it appears that an object coated with the film can be cleaned by water easily. Because there is no function of photo-catalyst in the film, organic material will not destroy to the structure of the product. Thereby, the film has preferred adhesive ability so that it can be widely used in furniture or daily-used articles.

### Fourth Embodiment

The process is identical to the third embodiment except that in the form-transfer process, 10 milliliters of silane is used to replace silicic acid. Operation conditions are same as the first embodiment. The acquired titanium dioxide sol-gel is transparent or yellow transparent solution with a pH value between 7 and 9. The content of titanium dioxide is 1%. The particle size is about 5 to 30 μm with needle-like or sheet-like crystals. The product can be directly used in spray treatment and then is processed as films by heating on manmade fiber/high molecular polymer products so as to have the function of self-cleaning. It can be washed easily. The product is performed with spraying treatment, and then dried at room temperature on a plastic articles to form as a thin film. Then adhesion test by using 3M tape is placed to the articles. No film falls off, but for the prior art film of titanium dioxide sol-gel without silicic acid, when the film is experienced with spraying treatment, the film will fall off in the test.

### Fifth Embodiment

The process is identical to the third embodiment except that the product is sprayed on ceramics coated with glaze (not sintered). Then they are sintered.

As a result, the surface of the ceramics is harder, pollution-proofed and easy to be washed.

### Sixth Embodiment

The process is same as the fourth embodiment, but in the form-transfer with spraying treatment, the film will fall off in the test.

### Fifth Embodiment

The process is identical to the third embodiment except that the product is sprayed on ceramics coated with glaze (not sintered). Then they are sintered. As a result, the surface of the ceramics is harder, pollution-proofed and easy to be washed.

### Sixth Embodiment

The process is same as the fourth embodiment, but in the form-transfer process, the amount of the filter cake and additives are increased to ten times than the original one. The product is dried in vacuum environment (with a temperature less than 70° C.) so as to form as powder. The powder can be used in the brightness surface treatment of various materials for increasing the wear-resistance of the material. Furthermore, the product is difficult to be polluted and is easy to be washed.

Advantages of the present invention is that the product of the present invention is difficult to be polluted and can be washed easily. Moreover, the present invention has preferred wear-resistance.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for synthesizing high adsorptive nanometer scale titanium dioxide solution comprising the steps of dissolving, diluting, neutralizing, and cleaning titanic compound in predetermined acid liquid to acquire clean powder of titanium hydroxide or titanic acid; after the powder precipitate in the acid liquid, the powder being synthesized into nanometer scale crystal titanium dioxide sol-gel with functions of photo-catalyst and self-cleaning; the method further comprising the steps of:
executing a form-transfer process in predetermined condition; clean titanic acid being agitated with de-ionized water and thus the titanic acid being uniformly mixed with de-ionized water; and then predetermined oxidants or inorganic acids, and modifiers being added to the de-ionized water solution;
executing a formation process; the form-transferred solution being performed with formation process in a predetermined temperature and time so as to get a sol-gel;
adjusting the pH of the sol-gel;
filtering the sol-gel from the solution; and
packaging the filtered sol-gel.

2. The method as claimed in claim 1, wherein the titanic compound is one of titanium hydroxide and titanic acid.

3. The method as claimed in claim 1, further comprising the step of mixing washed filtered cakes into the de-ionized water and then agitating the de-ionized water solution; and then adding the predetermined oxidant or inorganic acid and modifier/interface activator to the mixing solution.

4. The method as claimed in claim 1, wherein the oxidant is selected from at least one of perchloric acid, periodide acid, potassium permanganate, sodium permanganate, and nitric acid; and 1 to 200 grams/liters oxidant is added.

5. The method as claimed in claim 2, wherein the oxidant is selected from at least one of perchloric acid, periodide acid, potassium permanganate, sodium permanganate, and nitric acid; and 1 to 200 grams/liters oxidant is added.

6. The method as claimed in claim 1, wherein the inorganic acid is selected from at least one of perchloric acid, periodide acid, nitric acid, phosphoric acid, hydrochloric acid, sulfuric acid, and hydrogen iodide, hydrobromic acid; 1 to 120 grams inorganic acid is added to per liter solution.

7. The method as claimed in claim 2, wherein the inorganic acid is selected from at least one of perchloric acid, periodide acid, nitric acid, phosphoric acid, hydrochloric acid, sulfuric acid, and hydrogen iodide, hydrobromic acid; 1 to 120 grams inorganic acid is added to per liter solution.

8. The method as claimed in claim 1, wherein the organic acid is selected from one of oxalic acid, citric acid, picric acid, formic acid, acetic acid, benzoic acid, salicylic acid, and derivatives of ammonium compounds; and the added inorganic acid in the form transfer-process is between 0.1 gram/liter to 150 grams/liter.

9. The method as claimed in claim 2, wherein the organic acid is selected from one of oxalic acid, citric acid, picric acid, formic acid, acetic acid, benzoic acid, salicylic acid, and derivatives of ammonium compounds; and the added inorganic acid in the form transfer-process is between 0.1 gram/liter to 150 grams/liter.

10. The method as claimed in claim 1, wherein the modifier is selected from one of silicate, Poly-aluminum chloride(PAC), aluminum sulfate, silane depending on the final product required; the amount of modifier used in form-transfer process is between 0.05˜75 milliliter/liter.

11. The method as claimed in claim 2, wherein the modifier is selected from one of silicate, Poly-aluminium chloride(PAC), aluminium sulfate, silane depending on the final product required; the amount of modifier used in form-transfer process is between 0.05˜75 milliliter/liter.

12. The method as claimed in claim 1, wherein the surfactants used in form-transfer process is selected from one of polyvinyl alcohol (PVA); polypropylene alcohol (PPA); and mixture of polyvinyl alcohol (PVA)/polypropylene alcohol (PPA); poly-alcohols selecting from adding Polyethylene glycol, Polypropylene glycol and butadiene Polypropylene; and ploy-ethers selecting from Polyoxyethylene phenol ether/Polyoxypropylene alkyl phenol ether/Polyoxypropylene phenol ether/Polyoxypropylene alkyl phenol ether, and Polyoxyethylene Polyoxypropylene ether; and a molecular weight of the surfactants used in the form-transfer process is between 200-7000.

13. The method as claimed in claim 2, wherein the surfactants used in form-transfer process is selected from one of polyvinyl alcohol (PPA); polypropylene alcohol (PPA); and mixture of polyvinyl alcohol (PVA)/polypropylene alcohol (PPA); poly-alcohols selecting from adding Polyethylene glycol, Polypropylene glycol and butadiene Polypropylene; and ploy-ethers selecting from Polyoxyethylene phenol ether/Polyoxypropylene alkyl phenol ether/Polyoxypropylene phenol ether/Polyoxypropylene alkyl phenol ether, and Polyoxyethylene Polyoxypropylene ether; and a molecular weight of the surfactants used in the form-transfer process is between 200-7000.

14. The method as claimed in claim 1, wherein the amount of surfactants used in form-transfer process is between 10-15000 ppm and the agitating speed is between 30-300 rpm; the time for form-transfer process is 10 to 120 minutes; and the temperature in form-transfer process is retained at 10 to 95° C.

15. The method as claimed in claim 8, wherein the amount of surfactants used in form-transfer process is between 10-15000 ppm and the agitating speed is between 30-300 rpm; the time for form-transfer process is 10 to 120 minutes; and the temperature in form-transfer process is retained at 10 to 95° C.

16. The method as claimed in claim 1, wherein the solution after form-transfer process is executed with the formation process in an original tank or a predetermined formation tank; agitating speed in formation process is from 30 to 300 rpm with a temperature between 50 and 95° C. through a time period of 4 to 72 hours which are determined by a desired product; the sol-gel is performed with the process of pH adjusting, filtering, and package; wherein the pH adjustment is performed according to requirements of the product.
